(19) United States
(12) Patent Application Publication
(10) Pub. No.: US 2025/0038513 A1
(43) Pub. Date: Jan. 30, 2025

(54) OVERVOLTAGE/CURRENT DETECTION AND PROTECTION IN A WIRELESS POWER SYSTEM

(71) Applicant: Solace Power Inc., Mount Pearl (CA)

(72) Inventors: Samer ALDHAHER, London (GB); Mark HICKEY, Portugal Cove (CA); Samuel Robert COVE, Paradise (CA); Jonathan DAWE, Paradise (CA); Paul ARSENAULT, Mount Pearl (CA)

(73) Assignee: Solace Power Inc., Mount Pearl (CA)

(21) Appl. No.: 18/782,157

(22) Filed: Jul. 24, 2024

Related U.S. Application Data
(60) Provisional application No. 63/528,703, filed on Jul. 25, 2023.

(51) Int. Cl. H02H 3/02; H02H 3/06; H02H 3/08; H02H 3/20; H02H 7/22; H02J 50/05; H02J 50/12

(52) U.S. Cl. CPC H02H 3/023; H02H 3/066; H02H 3/08; H02H 3/20; H02H 7/22; H02J 50/05; H02J 50/12

(57) ABSTRACT

An overcurrent detection circuit for use in a transmitter of a wireless power transfer system is provided. The transmitter comprises a transmitter element for generating a field to transfer power to a receiver of a wireless power transfer system. The circuit is adapted to shut down a transmitter of a wireless power transfer system in response to a detected short circuit event. An overvoltage protection circuit for use in a receiver of a wireless power transfer system is also provided. The receiver comprises a receiver element for extracting power from a field generated by a transmitter of a wireless power transfer system, and a switching element electrically connected to the receiver element. The overvoltage protection circuit is adapted to electrically ground the switching element based on an overvoltage event.

### CROSS-REFERENCE TO RELATED APPLICATIONS

This application claims the benefit of U.S. Provisional Application No. 63/528,703 filed on Jul. 25, 2023, the entire content of which is incorporated herein by reference.

### FIELD

The subject disclosure relates generally to wireless power transfer, and in particular, to overvoltage/current detection and protection in a wireless power system.

### BACKGROUND

Wireless power transfer systems such as wireless charging are becoming an increasingly important technology to enable the next generation of devices. The potential benefits and advantages offered by the technology is evident by the increasing number of manufacturers and companies investing in the technology.

A variety of wireless power transfer systems are known. A typical wireless power transfer system includes a power source electrically connected to a wireless power transmitter, and a wireless power receiver electrically connected to a load.

The transmitter may generate an electric or magnetic field to transfer to the receiver via electric or magnetic field coupling. While electromagnetic energy is produced in electric systems, the majority of power transfer occurs via the electric field. Little, if any, power is transferred via magnetic field coupling. Similarly, while electromagnetic energy is produced in magnetic systems, the majority of power transfer occurs via the magnetic field. Little, if any, power is transferred via electric field coupling.

The receiver of a wireless power transfer system may need to be protected from an overvoltage event, i.e., the raising of voltage at the receiver beyond design tolerances. Additionally, it may be necessary to shut down the transmitter to stop or prevent an overvoltage event.

Accordingly, it is an object of the disclosure to provide overvoltage/current detection and protection in a wireless power system.

This background serves only to set a scene to allow a person skilled in the art to better appreciate the following description. Therefore, none of the above discussion should necessarily be taken as an acknowledgement that that discussion is part of the state of the art or is common general knowledge. One or more aspects/embodiments of the disclosure may or may not address one or more of the background issues.

### SUMMARY

According to an aspect of the disclosure there is provided an overcurrent detection circuit for use in a transmitter of a wireless power transfer system. The overcurrent detection circuit may be used to detect an overvoltage event and shut down or stop operation of the transmitter of the wireless power transfer system.

According to an aspect of the disclosure there is provided an overvoltage protection circuit for use in a receiver of a wireless power transfer system. The overvoltage protection circuit may electrically ground elements of the receiver of the wireless power transfer system based on an overvoltage event.

The described aspects may detect overcurrent/voltage and protect elements of a wireless power transfer system with greater efficiency than conventional solutions. In particular, the described aspects may be faster and more accurate than conventional solutions. Further, the described aspects may have smaller footprints thereby providing space savings.

According to another aspect of the disclosure, there is provided an overcurrent detection circuit for use in a transmitter of a wireless power transfer system, the transmitter comprising a transmitter element for generating a field to transfer power to a receiver of a wireless power transfer system, the overcurrent detection circuit adapted to shut down a transmitter of a wireless power transfer system in response to a detected overcurrent event.

The overcurrent event may comprise a short circuit.

The short circuit may be initiated by an overvoltage protection circuit at a receiver of a wireless power transfer system. The receiver may be adapted to extract power from a field generated by the transmitter. The receiver may be adapted to extract power via magnetic and/or electric field coupling. If the receiver is adapted to extract power via magnetic field coupling, little if any, power may be extracted via electric field coupling. If the receiver is adapted extract power via electric field coupling, little if any, power may be extracted via magnetic field coupling.

The short circuit may be initiated by the overvoltage protection circuit electrically grounding a component of a receiver of the wireless power transfer system to which the transmitter is transferring power. The component may be a switching element electrically connected to a receiver element of the receiver.

The overcurrent detection circuit may be adapted to shut down the transmitter in response to a current increase at the circuit.

The circuit may further comprise a current detector for detecting a current at the circuit.

The circuit may further comprise a voltage detector for detecting a voltage at the circuit. The circuit may be adapted to calculate a current at the circuit based on the detected voltage. The voltage detector may comprise a sensing resistor electrically connected to a differential amplifier for detecting a voltage across the sensing resistor. The current at the circuit may be calculated based on the detected voltage across the sensing resistor and a known resistance of the sensing resistor.

The circuit may further comprise a filter for filtering a signal at the circuit. The filter may be adapted to filter the detected voltage. The filter may filter the detected voltage to remove noise, extraneous data and/or harmonics.

The circuit may further comprise a comparator for comparing the detected current and/or voltage to a threshold value.

The circuit may be adapted to control operation of an inverter in response to the detected overcurrent event. The inverter may be electrically connected to the transmitter element. The overcurrent event may be detected based on a detected current/voltage at the circuit. The overcurrent event may be detected based on a current/voltage at the circuit exceeding a threshold value.

The inverter may be adapted to convert a DC power signal into a sinusoidal RF power signal. The inverter may be a push-pull inverter. The inverter may be comprise an amplifier.

The circuit may be adapted to control operation of one or more switching elements of an inverter. Each switching element may comprise a field effect transistor. The inverter may comprise two switching elements.

The circuit may be adapted to disable one or more driver circuits associated with switching elements of an inverter. A driver circuit may comprise a clock. The circuit may be adapted to enable one or more driver circuits associated with switching element of an inverter. The circuit may enable driver circuits (e.g., gate drivers) in response to a current at the transmitter reaches a threshold value. This threshold value may be lower than an initial threshold value which triggers the circuit to disable operation of the transmitter (by disabling operation of the inverter of the transmitter).

The circuit may be electrically connected to an inverter electrically connected to the transmitter element.

According to another aspect of the disclosure, there is provided a transmitter for a wireless power transfer system, the transmitter comprising a transmitter element for generating a field to transfer power to a receiver of a wireless power transfer system, the transmitter further comprising:
an overcurrent detection circuit adapted to detect a overcurrent event and shut down the transmitter.

The overcurrent event may comprise a short circuit.

The circuit may include any of the above described features.

The transmitter may further comprise a power source. The power source may output a power signal for generating a field for transferring power. The field may be an electric or magnetic field. The power signal may be a DC power signal.

The transmitter may further comprise a DC/DC converter for converting a voltage from one level to another, i.e., receiving an input voltage at one voltage level and providing an output voltage at a different level. The DC/DC converter may be electrically connected to an inverter. The converter may be electrically connected to a power source.

The transmitter may further comprise an inverter. The inverter may be adapted to convert a DC power signal into a sinusoidal RF power signal. The inverter may be a push-pull inverter. The inverter may be comprise an amplifier. The inverter may comprise one or more switching elements. Each switching element may comprise a field effect transistor. The inverter may comprise two switching elements.

The transmitter may further comprise a transmitter element. The transmitter element may comprise one or more transmitter coils for generating a magnetic field for transferring power to a receiver via magnetic field coupling. The transmitter element may comprise one or more transmitter electrodes for generating an electric field for transferring power to a receiver via electric field coupling. The transmitter element may generate a field for transferring power to a receiver, specifically a receiver element of a receiver. The transmitter element may resonate with an inductor or capacitor of the transmitter to generate the field.

According to another aspect there is provided an overvoltage protection circuit for use in a receiver of a wireless power transfer system, the receiver comprising a receiver element for extracting power from a field generated by a transmitter of a wireless power transfer system, and a switching element electrically connected to the receiver element, the overvoltage protection circuit adapted to electrically ground the switching element based on an overvoltage event.

The overvoltage protection circuit may provide fully analog overvoltage protection which save space and components compared to conventional solutions.

Additionally, the overvoltage protection circuit may prevent damage to components of the receiver, e.g., diodes, by electrically grounding the switching element.

The overvoltage protection circuit may be used in combination with the described overcurrent detection circuit at a transmitter of a wireless power transfer system. The overvoltage protection circuit electrically grounds the switching element, and subsequently the overcurrent detection circuit detects a overcurrent event, e.g., short circuit, as a result. The overcurrent detection circuit shuts down the transmitter before any damage can be done at the transmitter. Such a combination of circuit may eliminate the use of communication modules to communicate the overvoltage event from the receiver to the transmitter. Additionally, such communication may be comparatively slow which could result in damage to components at the transmitter.

The receiver may comprise a rectifier. The rectifier may comprise the switching element. The rectifier may comprise a synchronous rectifier such as applicant's own rectifier described in U.S. Pat. No. 11,637,453 B2, the relevant portions of which are incorporated herein by reference. The switching element may comprise a field effect transistor (FET).

The overvoltage protection circuit may be electrically connected to an output of the switching element. The overvoltage protection circuit may be electrically connected directly to the output of the switching element.

The overvoltage protection circuit may be adapted to detect the overvoltage event. The overvoltage event may be detectable based on a voltage at an output of the receiver element of the receiver.

The overvoltage event may correspond to over-coupling between the receiver element and a transmitter element of a transmitter of a wireless power transfer system. Over-coupling may occur due to the elements transferring power at distances closer than their originally intended use. In other words, the transmitter and receiver may be designed to operate at a particular separation distance between elements. When the elements are brought closer together than this separation distance, over-coupling may occur.

The overvoltage protection circuit may be adapted to monitor a voltage. The voltage may be at an output of the receiver element of the receiver.

The overvoltage protection circuit is electrically connected in parallel to the switching element. The circuit may be electrically connected directly to the switching element in parallel.

The overvoltage protection circuit may be adapted to be electrically open when a voltage at the receiver element is below a threshold value.

The overvoltage protection circuit may be adapted to short circuit the switching element to ground when the voltage at the switching element exceeds the threshold value. The voltage may be at an output of the switching element.

The overvoltage protection circuit may be adapted to again be electrically open when no power signal is present at the switching element. The overvoltage protection circuit may be electrically open, then short circuit the switching element when a voltage at the switching element exceeds a threshold voltage, and then be electrically open when no power signal is present at the switching element. The overvoltage protection circuit may be adapted to be electrically open after the switching element has been short circuited to ground once the power signal is reduced to approximately zero.

The overvoltage protection circuit may be an analog circuit. An analog circuit may be smaller and save space compared to conventional solutions which involve communication modules and/or microcontrollers.

The overvoltage protection circuit may comprise a switching element.

The overvoltage protection circuit may comprise a latching element.

The overvoltage protection circuit may comprise a triode for alternating current (TRIAC). The TRIAC may operate as a latching element. The TRIAC may be adapted to electrically ground the switching element until a no power signal is present at the switching element, i.e., the power signal is zero.

The overvoltage protection circuit may be adapted to sample a power signal. The power signal may be the signal received at the receiver. The power signal may be signal extracted via magnetic or electric field coupling from a field generated by a transmitter of a wireless power transfer system.

According to another aspect of the disclosure, there is provided a receiver for a wireless power transfer system, the receiver comprising a receiver element for extracting power from a field generated by a transmitter of a wireless power transfer system, and a switching element electrically connected to the receiver element, the receiver further comprising an overvoltage protection circuit for electrically grounding the switching element, the overvoltage protection circuit electrically connected to the switching element and the receiver element.

The overvoltage protection circuit of the receiver may comprise all of the features and elements described with respect to the aforementioned aspect.

The receiver element may comprise one or more receiver coils for extracting power via magnetic field coupling from a magnetic field generated by a transmitter, in particular one or more transmitter coils. The receiver element may comprise one or more receiver electrodes for extracting power via electric field coupling from an electric field generated by a transmitter, in particular one or more transmitter electrodes. The receiver element may resonate with an inductor or capacitor of the receiver to extract power from a generated field.

The receiver may comprise a rectifier. The rectifier may comprise the switching element. The rectifier may comprise a synchronous rectifier such as applicant's own rectifier described in U.S. Pat. No. 11,637,453 B2, the relevant portions of which are incorporated herein by reference. The switching element may comprise a field effect transistor (FET).

The rectifier may be electrically connected to the receiver element. The rectifier may be electrically connected directly to the receiver element.

The receiver may further comprise a DC/DC converter for converting a voltage from one level to another, i.e., receiving an input voltage at one voltage level and providing an output voltage at a different level. The DC/DC converter may be electrically connected to a rectifier. The converter may be electrically connected to a load.

The receiver may further comprise a load. The load may be powered by power wirelessly transferred from a transmitter to the receiver.

According to another aspect of the disclosure, there is provided a method of protecting a switching element of a receiver of a wireless power transfer system from a receiver element of the receiver, the receiver element for extracting power from a field generated by a transmitter of a wireless power transfer system, the method comprising:
electrically grounding, via an overvoltage protection circuit, a switching element of a receiver, the overvoltage protection circuit electrically connected to the switching element and the receiver element.

The overvoltage protection circuit may comprise any of the features or elements described in aforementioned aspects.

The method may further comprise:
tapping the overvoltage protection circuit off of the receiver element.

Electrically grounding may comprise electrically grounding the switching element based on an overvoltage event.

The overvoltage event may correspond to over-coupling between the receiver element and a transmitter element of a transmitter of a wireless power transfer system.

The method may further comprise:
opening the overvoltage protection circuit when a voltage at the receiver element is below a threshold value.

The method may further comprise:
short circuiting, via the overvoltage protection circuit, the receiver element to ground when the voltage at the receiver element is below a threshold value.

The method may further comprise:
re-opening the overvoltage protection circuit when no power signal is present at the receiver element. Re-opening may occur after the short circuiting. Short circuiting may occur after the initial opening.

According to another aspect of the disclosure, there is provided a method of detecting overcurrent at a transmitter of a wireless power transfer system, the transmitter comprising a transmitter element for generating a field to transfer power to a receiver of a wireless power transfer system, the method comprising:
shutting down a transmitter of a wireless power transfer system in response to a detected overcurrent event.

The overcurrent event may comprise a short circuit.

The method may further comprise:
detecting a current increase at the transmitter to detect the short circuit.

The method may further comprise: filtering a signal at the transmitter.

The signal may be the detected current.

Shutting down the transmitter may comprise controlling operation of an inverter of the transmitter. The inverter may be electrically connected to a transmitter element of the transmitter. The transmitter element may be adapted to generate a field for wirelessly transferring power to a receiver of a wireless power transfer system. Inverter operation may be controlled in the manner previously described.

The method may be performed by the described overcurrent detection circuit.

According to another aspect of the disclosure, there is provided a method comprising:
electrically grounding, via an overvoltage protection circuit, a switching element of a receiver of a wireless power transfer system, the switching element electrically connected to a receiver element of the receiver, the receiver element extracting power from a field generated by a transmitter of the wireless power transfer system; and
in response to the electrically grounding, shutting down the transmitter.

The overvoltage protection circuit may comprise any of the features or elements described in respect of the aforementioned aspects.

Shutting down the transmitter may comprise controlling operation of an inverter of the transmitter. The inverter may be electrically connected to a transmitter element of the transmitter. The transmitter element may be adapted to generate a field for wirelessly transferring power to the receiver. Inverter operation may be controlled in the manner previously described.

The shutting down may be performed by the describe overcurrent detection circuit.

The phrase “electrically connected” may refer to a direct electrical connection between two elements, or an indirect electrical connection between two elements with one or more additional elements between the two elements, unless otherwise stated.

The disclosure includes one or more corresponding aspects, embodiments or features in isolation or in various combinations whether or not specifically stated (including claimed) in that combination or in isolation. As will be appreciated, features associated with particular arrangements relating to systems may be equally appropriate as features of embodiments relating specifically to methods of operation or use, and vice versa.

The above summary is intended to be merely exemplary and non-limiting.

### BRIEF DESCRIPTION OF THE DRAWINGS

A description is now given, by way of example only, with reference to the accompanying drawings, in which:

FIG. 1 is a block diagram of a wireless power transfer system;

FIG. 2 is another block diagram of a wireless power transfer system;

FIG. 3 is a block diagram of a wireless power transfer system in accordance with an aspect of the disclosure;

FIG. 4a is a circuit diagram of a receiver portion of the wireless power transfer system of FIG. 3;

FIG. 4b is a circuit diagram of another arrangement of a receiver portion of the wireless power transfer system of FIG. 3;

FIG. 5 is a circuit diagram of the overvoltage protection circuit of FIGS. 4a and 4b;

FIG. 6a is a circuit diagram of a transmitter portion of the wireless power transfer system of FIG. 3;

FIG. 6b is a circuit diagram of another arrangement of the transmitter portion of FIG. 6a;

FIG. 7 is a plot of voltage and current versus time for the wireless power transfer system of FIG. 3; and

FIG. 8 is a flowchart of operation of an overvoltage protection and detection circuits in accordance with an aspect of the disclosure.

### DETAILED DESCRIPTION

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings. It will also be appreciated that like reference characters will be used to refer to like elements throughout the description and drawings.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, and/or designed for the purpose of performing the function. It is also within the scope of the subject application that elements, components, and/or other subject matter that is described as being adapted to perform a particular function may additionally or alternatively be described as being configured to perform that function, and vice versa. Similarly, subject matter that is described as being configured to perform a particular function may additionally or alternatively be described as being operative to perform that function.

It will be understood that when an element is referred to as being “on,” “attached” to, “connected” to, “coupled” with, “contacting,” etc., another element, it can be directly on, attached to, connected to, coupled with or contacting the other element or intervening elements may also be present.

It should be understood that use of the word “exemplary”, unless otherwise stated, means ‘by way of example’ or ‘one example’, rather than meaning a preferred or optimal design or implementation.

Unless defined otherwise, all technical and scientific terms used herein have the same meaning as is commonly understood by one of skill in the art to which the subject disclosure pertains.

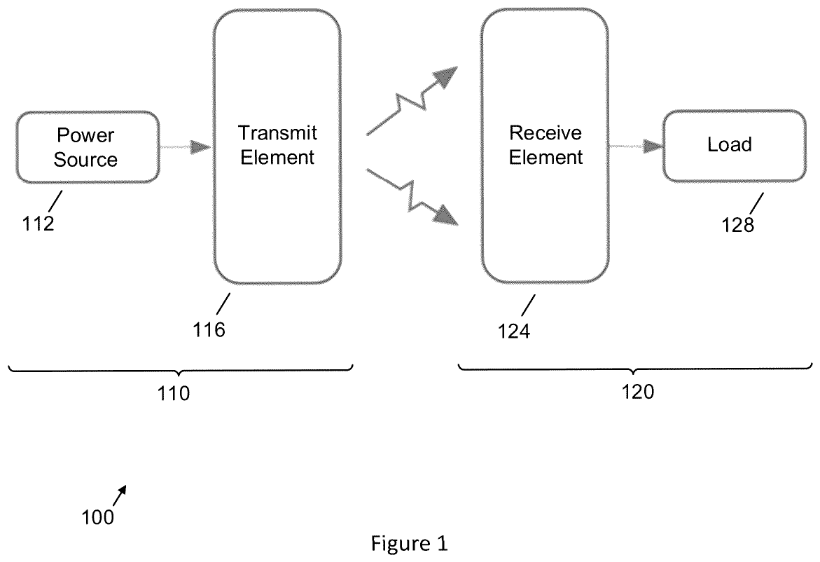

Turning now to FIG. 1, a wireless power transfer system generally identified by reference numeral 100 is shown. The wireless power transfer system 100 comprises a transmitter 110 comprising a power source 112 electrically connected to a transmitter element 116, and a receiver 120 comprising a receiver element 124 electrically connected to a load 128. Power is transferred from the power source 112 to the transmitter element 116. The power is then transferred from the transmitter element 116 to the receiver element 124 via resonant or non-resonant electric or magnetic field coupling. The power is then transferred from the receiver element 124 to the load 128. Exemplary wireless power transfer systems 100 include a high frequency inductive wireless power transfer system as described in applicant's U.S. Provisional Application No. 62/899,165, or a resonant capacitively coupled wireless power transfer system as described in applicant's U.S. Pat. No. 9,653,948B2, the relevant portions of which are incorporated herein.

In the wireless power transfer system 100, power is transferred from the transmitter element 116 to the receiver element 124. It may be desirable to be able to transfer power to and from each respective element, i.e., from receiver element 124 to transmit 116.

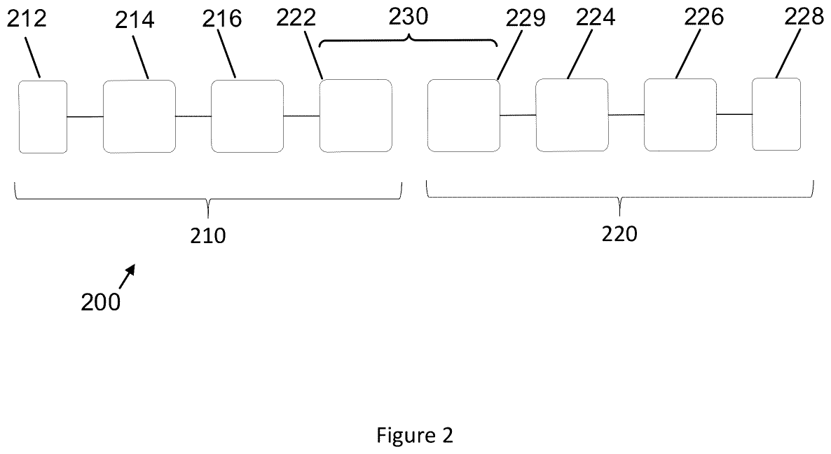

Turning now to FIG. 2, another embodiment of a wireless power transfer system is shown generally identified as reference numeral 200. The wireless power transfer system 200 comprises a power supply 212, DC/DC converter 214, inverter 216, and transmitter element 222. The power supply 212 is electrically connected to the DC/DC converter 214. The DC/DC converter 214 is electrically connected to the inverter 216. The inverter 216 is electrically connected to the transmitter element 222.

The power supply 212 is for generating an input power signal for transmission of power. In this embodiment, the input power signal is a direct current (DC) power signal.

The DC/DC converter 214 is for converting a received DC voltage signal to a desired voltage level. The received DC voltage may be from the power supply 212. The system 200 is illustrated as comprising the DC/DC converter 214, one of skill in the art will appreciate other configurations are possible. In another embodiment, no DC/DC converter is present.

In the illustrated arrangement, the inverter 216 comprises inverter circuitry and an output stage. The output stage matches the output impedance of the inverter circuitry to the optimum impedance of a wireless link 230 between the transmitter and receiver. The output stage may also set the desired impedance presented to the inverter circuitry. The output stage also filters high frequency harmonic components of the inverter. One of skill in the art will appreciate that the output stage may be omitted.

The transmitter element 222 comprises one or more capacitive electrodes and inductive elements, i.e., inductors. The capacitive electrodes may be laterally spaced, elongated electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. The inductive elements may comprise one or more coils. The coils may include booster or shield coils such as described in applicant's U.S. patent application Ser. No. 17/193,539, the relevant portions of which are incorporated herein by reference. The transmitter element 222 may further include resonator elements for resonating the capacitive electrodes and inductive elements, i.e., capacitors and inductors.

The power source 212 supplies a DC input power signal to the DC/DC converter 214 which converts the signal to a desired voltage level. The inverter 216 receives the converted DC power signal and converts the DC power signal to AC to allow the ability to generate a magnetic and/or electric field at the transmitter element 222 to transfer power via electric or magnetic field coupling. Specifically, the transmitter element 222 generates a magnetic/electric field to transfer power to the receiver via magnetic/electric field coupling. The power source 212, DC/DC converter 214, inverter 216 and transmitter element 222 may collectively form a transmitter 210. As previously stated, the DC/DC converter 214 may not be present in the transmitter 210.

The wireless power transfer system 200 further comprises load 228, DC/DC converter 226, rectifier 224, and receiver element 229. The load 228 is electrically connected to the DC/DC converter 226. The DC/DC converter 226 is electrically connected to the rectifier 224. The rectifier 224 is electrically connected to the receiver element 229.

In the illustrated arrangement, the load 228 is a DC load. The load 228 may be static or variable.

The DC/DC converter 226 is for converting a received DC voltage signal to a desired voltage level. The received DC voltage may be from the circuitry 224. While the system 200 comprises the DC/DC converter 226, one of skill in the art will appreciate other configurations are possible. In another embodiment, no DC/DC converter 226 is present.

The rectifier 224 comprises an input stage and rectifier circuitry. The input stage is configured to ensure optimum impedance presented to the receiver element 229 at the full power state of the wireless power transfer system 200. The input stage may also preserve the quasi-voltage source behaviour of the receiver element 229 so the output of the rectifier 224 exhibits a stable DC voltage from no load to full load conditions. One of skill in the art will appreciate that the input stage may be omitted. The rectifier 224 may comprise a synchronous rectifier such as applicant's own rectifier described in U.S. Pat. No. 11,637,453 B2, the relevant portions of which are incorporated herein by reference.

The receiver element 229 comprises one or more capacitive electrodes and inductive elements, i.e., inductors. The capacitive electrodes may be laterally spaced, elongate electrodes; however, one of skill in the art will appreciate that other configurations are possible including, but not limited to, concentric, coplanar, circular, elliptical, disc, etc., electrodes. Other suitable electrode configurations are described in applicant's U.S. Pat. No. 9,979,206B2, the relevant portions of which are incorporated herein by reference. The inductive elements may comprise one or more coils. The coils may include booster or shield coils such as described in applicant's U.S. patent application Ser. No. 17/193,539, the relevant portions of which are incorporated herein by reference.

The transmitter and receiver elements 222, 229 of the system 200 form the wireless link 230. The elements 222, 229 are separated by a wireless gap. The wireless gap may be formed by atmosphere, i.e., air, or by a physical medium, e.g., walls, glass, liquids, wood, insulations, etc. Power is transferred from one element to the other across the wireless link 230 via resonant or non-resonant magnetic and/or electric field coupling, i.e., electric or magnetic induction.

During operation, the receiver element 229 extracts power from a magnetic and/or electric field generated by the transmitter element 222. The rectifier 224 rectifies the received power signal. The DC/DC converter 226 converts the rectified power signal to the desired power level which is received by the load 228. In this way, the receiver element 229 extracts power transmitted by the transmitter element 222 (transmitter 210) such that electrical power is transferred to the load 228 via magnetic/electric field coupling. The load 228, DC/DC converter 226, rectifier 224 and receiver element 229 may collectively form a receiver 220. As previously stated, the DC/DC converter 226 may not be present in the receiver 220.

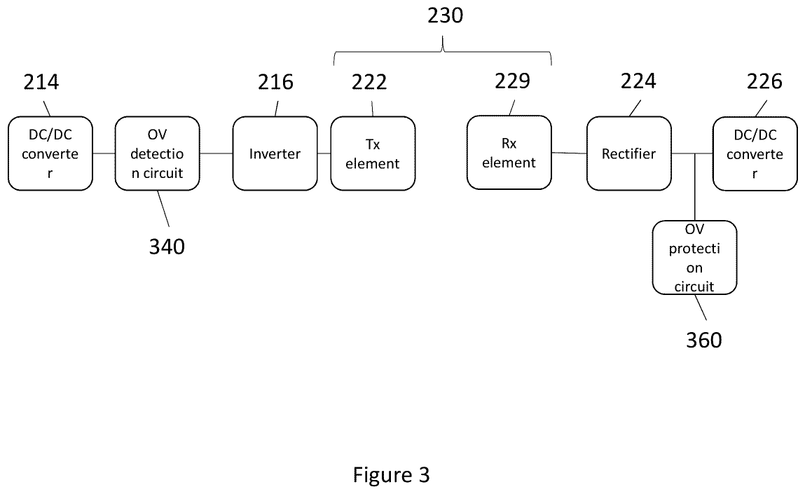

Turning now to FIG. 3, another arrangement of the wireless power transfer system 200 is illustrated. In this arrangement, the transmitter 210 further comprises an overcurrent detection circuit 340. Additionally, the receiver 220 further comprises an overvoltage protection circuit 360. While the power source 212 at the transmitter 210 is not illustrated in FIG. 3, nor the load 228 at the receiver 220, this is simply for clarity. These elements may still be present in the described arrangement. Further, the DC/DC converters 214 and 226 of the transmitter 210 and receiver 220 may be omitted entirely if the input power signal from the power source 212 is suitable for the inverter 216, and the output power signal from the rectifier 224 is suitable for the load 228, respectively.

The transmitter 210 and receiver 220 may include additional elements such as RF circuits for tuning the transmitter and receiver elements 222, 229, respectively. These circuits may comprise one or more inductors, capacitors, resistors and other electrical elements. An RF circuit may be electrically connected between the inverter 216 and transmitter element 222 of the transmitter 210. An RF circuit may be electrically connected between the receiver element 229 and the rectifier 224 of the receiver 220.

The overcurrent detection circuit 340 is electrically connected to the input of the inverter 216. The overvoltage protection circuit 360 is electrically connected to the output of the rectifier 224, specifically a switching element of the rectifier 224 as will be described.

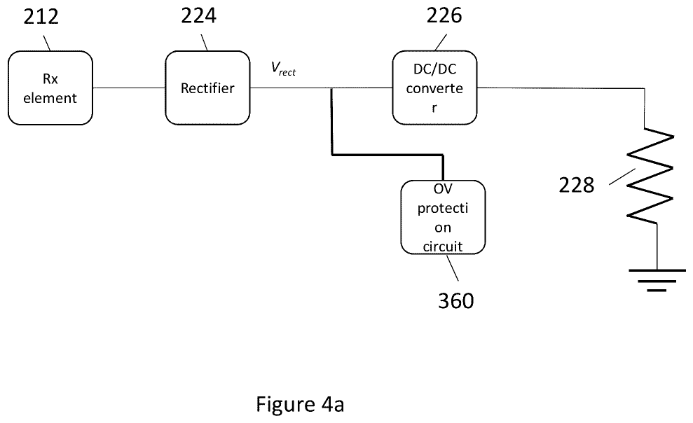

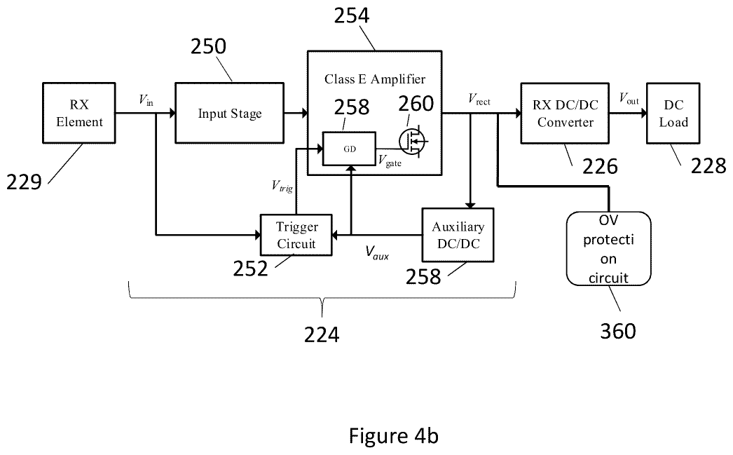

Turning now to FIGS. 4a and 4b, two different arrangements of the receiver 220 are illustrated. In FIG. 4a, one arrangement of the rectifier 224 is shown. In FIG. 4b, another arrangement of the rectifier 224 is shown. In the arrangement illustrated in FIG. 4b, the rectifier 224 is a synchronous rectifier, while in the arrangement illustrated in FIG. 4a, the rectifier 224 is non-synchronous.

In both arrangements, the overvoltage protection circuit 360 is electrically connected to the output of the rectifier 224. The circuit 360 is adapted to electrically ground a switching element of the rectifier 224 based on an overvoltage event.

Turning to FIG. 4a, the overvoltage protection circuit 360 is electrically connected to an output of a switching element of the rectifier 224. The rectifier 224 rectifies a power signal extracted by the receiver element 229 from a field generated by the transmitter 210.

The overvoltage protection circuit 360 is electrically connected to the output of the rectifier 224. Specifically, the circuit 360 is electrically connected to the output of a switching element of the rectifier 224. As shown in FIG. 4a, the overvoltage protection circuit 360 is an analog circuit. As will be described and illustrated, the overvoltage protection circuit 360 comprises a TRIAC.

The overvoltage protection circuit 360 detects an overvoltage event at the receiver 220 and short circuits the switching element of the rectifier 224. The overvoltage protection circuit 360 monitors a voltage at the output of the switching element. When the voltage exceeds a threshold, the overvoltage protection circuit 360 short circuits the switching element to ground. When the voltage drops to zero, which may mean the power signal at the receiver element 229 is now zero, the overvoltage protection circuit 360 is electrically open, i.e., the switching element is no longer grounded. The switching element can then again be grounded by the overvoltage protection circuit 360 once the voltage again exceeds the threshold.

Turning to FIG. 4b, the rectifier 224 is a synchronous rectifier. The synchronous rectifier may be applicant's own synchronous rectifier described in U.S. Pat. No. 11,637,453 B2, the relevant portions of which are incorporated herein by reference. The synchronous rectifier rectifies a power signal extracted by the receiver element 229 from a field generated by the transmitter 210.

In this arrangement, the synchronous rectifier comprises an input stage 250 for ensuring optimum impedance presented to the receiver element 229. The input stage 250 may also preserve the quasi-voltage source behaviour of the receiver element 229 so the output of the synchronous rectifier exhibits a stable DC voltage from no load to full load conditions. In addition to the input stage 250, the rectifier 224 comprises a trigger circuit 252, a rectifier element 254, a gate driver 256 and an auxiliary DC/DC converter 258.

The receiver element 229 is electrically connected to the input stage 250 and trigger circuit 252. The receiver element 229 is configured to receive power from a transmitter, e.g. transmitter 210, using resonant or non-resonant electric or magnetic field coupling. The receiver element 229 may extract power from a transmitter via non-resonant or resonant magnetic or electric field coupling. As such, the receiver element 229 comprises one or more receive coils (i.e. inductors) or one or more capacitive electrodes. The corresponding transmitter comprises corresponding transmit coils (i.e. inductors) or capacitive electrodes, respectively.

The receiver element 229 extracts power from the transmitter and as such outputs an input voltage or signal Vin which corresponds to the extracted power or signal. The input stage 250 is electrically connected to the rectifier element 254, receiver element 229 and trigger circuit 252. The input stage 250 is adapted to perform any combination of three functions. In particular, the input stage 250 is for converting the impedance presented by the rectifier element 254 under nominal loading to the optimal load impedance for the receiver element 229. The input stage 250 is for reducing harmonic content generated by the nonlinear action of the rectifier element 254 such that the receiver 220, and by extension, the wireless power system that the receiver 220 forms a part of, may meet international product requirements relating to electromagnetic compatibility (EMC). The input stage 250 is for ensuring that current input into the rectifier element 254 is approximately sinusoidal.

In this embodiment, the input stage 250 comprises a matching network or circuit. Various matching networks are possible. In this embodiment, the matching network takes the form of a double stage impedance inverter. The double stage impedance inverter is electrically connected to the receiver element 229. The input stage 250 may further comprise additional filtering added in series with the rectifier element 254. The use of the double impedance inverter topology may beneficially ensure the rectifier element 254 is driven by a quasi-constant voltage source. While a double stage impedance inverter is described, one of skill in the art will appreciate the matching network may take the form of a single stage impedance inverter.

The input stage 250 is configured to ensure optimum impedance presented to the receiver element 229 at the full power state of the wireless power transfer system 200.

The input stage 250 may also preserve the quasi-voltage source behaviour of the receiver element 229 so the output of the synchronous rectifier exhibits a stable DC voltage from no load to full load conditions.

The rectifier element 254 is electrically connected to the input stage 254, the primary

DC/DC converter 226, i.e., the primary DC/DC converter and the auxiliary DC/DC converter 258.

The rectifier element 254 comprises an amplifier. The amplifier is a class E amplifier. The amplifier comprises the gate driver 258 and a main switch. The gate driver 258 drives the main switch of the amplifier. In this embodiment the main switch comprises an n-type MOSFET 260. While an n-type MOSFET 260 has been illustrated, one of skill in the art will appreciate other FETs and switching devices may be used.

The DC/DC converter 226 is electrically connected to the rectifier element 254, auxiliary DC/DC converter 258 and load 228, e.g., DC load. The primary DC/DC converter 226 is for receiving the DC power signal output from the rectifier element 254, Vrect. The DC/DC converter 226 interfaces the rectifier element 254 to the load 228. The DC/DC converter 226 is for converting the received DC power signal. The converted DC power signal is output from the DC/DC converter 226 to the load 228. The auxiliary DC/DC converter 258 is additionally electrically connected to the primary DC/DC converter 226. The auxiliary DC/DC converter 258 is electrically connected to DC/DC converter 226, trigger circuit 252 and gate driver 258 of the rectifier element 254. The auxiliary DC/DC converter 258 is for converting the Vrect output by the rectifier element 254 to an auxiliary voltage range, e.g. in the range of 5V, Vaux, to power the trigger circuit 252 and gate driver 258. The auxiliary power voltage or signal Vaux powers the trigger circuit 252 and gate driver 258. Until the auxiliary DC/DC converter 258 can regulate, the FET 260 of the rectifier element 254 is off and the rectifier element 254 acts as a passive (diode) rectifier. In this embodiment, the auxiliary DC/DC converter 258 comprises a low-power buck converter.

The gate driver 258 is electrically connected to the rectifier element 254, the auxiliary DC/DC converter 258 and the trigger circuit 252. The gate driver 258 is powered by a signal, e.g. Vaux, from the auxiliary DC/DC converter 258. The gate driver 258 outputs a signal to switch the FET 260 of the rectifier element 254. In particular, the gate driver 258 outputs a gate drive voltage or gate signal, Vgate, to control operation of the rectifier element 254, e.g. control switching of the FET 260 of the rectifier element 254.

The trigger circuit 252 is electrically connected to the rectifier element 254. The trigger circuit 252 is for is for synchronizing wireless power transfer. The trigger circuit 252 is further electrically connected to the receiver element 229 and the input stage 250. To address the challenge of the non-negligible propagation delays from the gate driver 258 and the trigger circuit 252, the trigger circuit 252 is designed such that the trigger circuit 252 further delays the output signal Vtrig to ensure Vgate is synchronized with Vin.

The load 228 is electrically connected to the DC/DC converter 226. The load 228 receives the signal output by the DC/DC converter 226, Vout. The load 228 may be variable. As one of skill in the art will appreciate, the load 228 may be directly connected to the rectifier element 254 and received Vrect if DC conversion is not required.

The gate signal, Vgate, controls operation of the current between the source and drain of the FET 260 thus controlling rectification of the input signal, Vin, received at the receiver element 229. As the gate signal is in phase with the input signal, the FET 260 operates as a class E inverter. A class E inverter generally operates at high efficiency resulting in a high efficiency rectifier.

While the receiver 220 has been described as comprising the input stage 250 and DC/DC converter 226, one of skill in the art will appreciate that other configurations are possible. In particular, the receiver 220 may not comprise either one or both of the input stage 250 and the DC/DC converter 226.

As stated, the overvoltage protection circuit 360 is electrically connected to the output of the rectifier 224. Specifically, the circuit 360 is electrically connected to the output of the FET 360, i.e., the switching element of the rectifier 224.

As shown in FIG. 4b, the overvoltage protection circuit 360 is an analog circuit. As will be described and illustrated, the overvoltage protection circuit 360 comprises a TRIAC.

The overvoltage protection circuit 360 detects an overvoltage event at the receiver 220 and short circuits the FET 260 upon detect of the overvoltage event. Specifically, the overvoltage protection circuit 360 monitors a voltage at the output of the FET 260, i.e., Vrect. When the voltage exceeds a threshold, the overvoltage protection circuit 360 short circuits the FET 260 to ground. When the voltage drops to zero, which may mean the power signal at the receiver element 229 is now zero, the overvoltage protection circuit 360 is electrically open, i.e., the FET 260 is no longer grounded. The FET 260 can then again be grounded by the overvoltage protection circuit 360 once the voltage again exceeds the threshold.

In operation, the overvoltage protection circuit 360 electrically grounds a switching element of the rectifier 224 (either rectifier illustrated in FIGS. 4a and 4b). The circuit 360 monitors a voltage at the output of the rectifier 224 to determine if an overvoltage event (i.e., the voltage exceeding a predetermined threshold) has occurred. If the voltage has exceeded the threshold, the circuit 360 electrically grounds the switching element. The voltage may exceed a threshold due to over-coupling between the receiver element 229 and the transmitter element 222. Once the voltage has been reduced to zero, the circuit 360 stops electrically grounding the switching element, i.e., the circuit 360 switches to open. If the voltage again exceeds the threshold, the circuit 360 will again electrically ground the switching element. By electrically grounding the switching element upon detection of an overvoltage event, the circuit 360 protects elements of the DC/DC converter 226 and elements of the rectifier 224 (e.g., diodes and other electrical components) and load 228. Excess voltage at these elements may damage them. The circuit 360 ensures they are not damaged.

Over-coupling may occur due to the elements 222, 229 transferring power at distances closer than their originally intended use. In other words, the transmitter 210 and receiver 220 may be designed to operate at a particular separation distance between elements 222, 229. When the elements 222, 229 are brought closer together than this separation distance, over-coupling may occur.

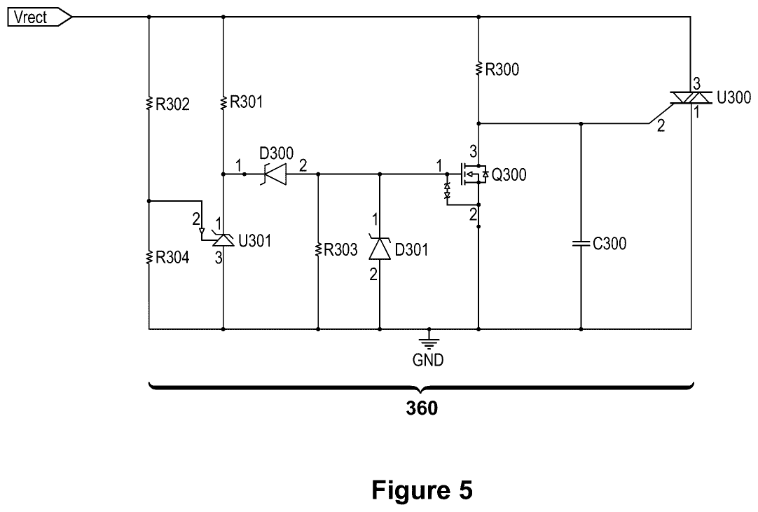

While the overvoltage protection circuit 360 has been described generally, a particular arrangement of the circuit 360 is presented in FIG. 5. The circuit 360 may be used with the rectifier of FIG. 4a or FIG. 4b. The circuit 360 may comprise a crowbar circuit. In this arrangement, the overvoltage protection circuit 360 comprises resistors R302, R304 connected to form a voltage divider, and the reference pin of the shunt regulator U301 electrically connected between resistors R302, R304. Shunt regulator U301 is further electrically connected to resistor R301. A cathode of Zener diode D300 is electrically connected to the junction of resistor R301 and shunt regulator U301. Resistor R303 and Zener diode D301 are electrically connected together in parallel between an anode of the Zener diode D300 and ground. A switching element is electrically connected to the Zener diode D300 and ground. In this arrangement, the switching element comprises a FET, specifically and NMOSFET Q300. The gate of the NMOSFET Q300 is electrically connected to the anode of the Zener diode D300, resistor R303 and Zener diode D301. The NMOSFET Q300 is also electrically connected to resistor R300. A capacitor C300 is electrically connected to the junction of NMOSFET Q300 and resistor R300. A triac U300 is electrically connected to NMOSFET Q300 with the capacitor C300 connected between the gate of triac U300 and ground. Capacitor C300 is used for filtering and stability.

Resistors R302 and R304 form a voltage divider connected to the reference pin of a shunt regulator U301. This controls the trip point, i.e., voltage threshold, at which the overvoltage protection circuit 360 will electrically ground the rectifier 224. The diode D300 is used to improve stability during start-up of power transfer from the transmitter 210 to the receiver 220.

When the voltage at the reference pin of the shunt regulator U301 is lower than the voltage threshold (trigger point), e.g., less than 2.5 V, the shunt regulator U301 operates in a high impedance mode. When the voltage at the reference pin of the shunt regulator U301 is equal to or above the voltage threshold (trigger point), e.g., greater than or equal to 2.5V, the shunt regulator U301 operates in a low impedance mode.

In operation when the voltage Vrect is less than the voltage threshold, i.e., crowbar inactive, the shunt regulator U301 operates in a high impedance mode. As a result of operating in a high impedance mode, the gate terminal of NMOSFET Q300 is pulled high through the voltage divider formed by resistors R301 and R303. The gate terminal of the NMOSFET Q300 is protected from overvoltage by Zener diode D301. Pulling the gate terminal of the NMOSFET Q300 high allows the NMOSFET Q300 to conduct (low impedance). With NMOSFET Q300 conducting, the gate terminal of the triac U300 is pulled to ground potential. The triac U300 requires a positive current to flow into its gate terminal to allow it to conduct between its main terminals. With the gate terminal of the triac U300 grounded, no current can flow into its gate terminal and the triac U300 remains open. Thus, the voltage output from the rectifier 224, Vrect, is transferred from the rectifier 224 to the DC/DC converter 226 or directly to the load 228 if the DC/DC converter 226 is not present.

When the voltage Vrect exceeds the threshold e.g., 55 V, the output of the voltage divider reaches 2.5V and the shunt regulator U301 begins to conduct. The shunt regulator U301 switches from operating in a high impedance mode to operating in a low impedance mode. This pulls the gate terminal of the NMOSFET Q300 low, causing the NMOSFET Q300 to stop conducting (high impedance). As a result, the gate terminal of the triac U300 is no longer pulled to ground potential, and current is allowed to flow into the gate terminal through resistor R300. Resistor R300 is sized, i.e., an appropriate resistance is selected, to allow adequate gate threshold current to flow into the circuit 360 at the voltage threshold, i.e., trip point, of the crowbar. This causes the triac U300 to begin conducting through its main terminals. As a result, the output of the rectifier is shorted to ground, i.e., shorting Vrect to GND.

Once the Triac U300 is turned on, i.e., conducting through its main terminals, the circuit 340 will remain latched in the on position until the current flowing through the main terminal falls below the latching current. This only occurs when the receiver 220 loses power and fully shuts down.

In an exemplary arrangement of the circuit 360 illustrated in FIG. 5, resistors R302, R301, R303 each have a resistance of 100 kΩ; resistors R300, R304 each have a resistance of 10 kΩ; and capacitor C300 has a capacitance of 1 nF. One of skill in the art will appreciate these values are exemplary and other values may be used.

As mentioned, once an overvoltage event occurs, the circuit 360 electrically grounds the switching element of the rectifier 224. The output voltage will decrease once the switching element has been electrically grounded. The receiver element 229 may continue to extract power from a field generated by the transmitter element 222 even after the overvoltage event. For the circuit 360 to no longer electrically ground the switching element, the output voltage of the switching element needs to reduce to zero. One way to accomplish this is to stop the transmitter 210 from generating a field. The transmitter 210 will stop generating a field if a current to the transmitter element 222 is reduced to reduce to zero. Once the current to the transmitter element 222 is zeroed, no further power will be extracted by the receiver element 229 and the output of the switching element of the rectifier 224 will reduce to zero. The circuit 360 will then switch to electrically open, and the rectified voltage output by the rectifier 224 can increase again to be output to the DC/DC converter 226 and load 228.

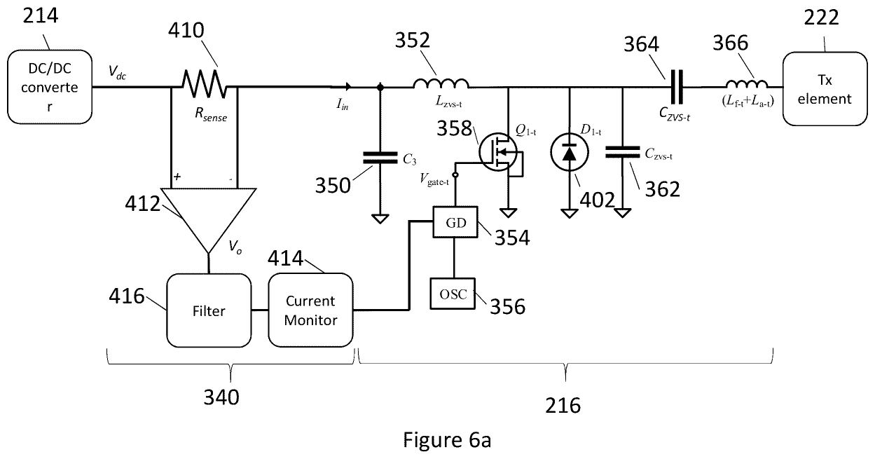

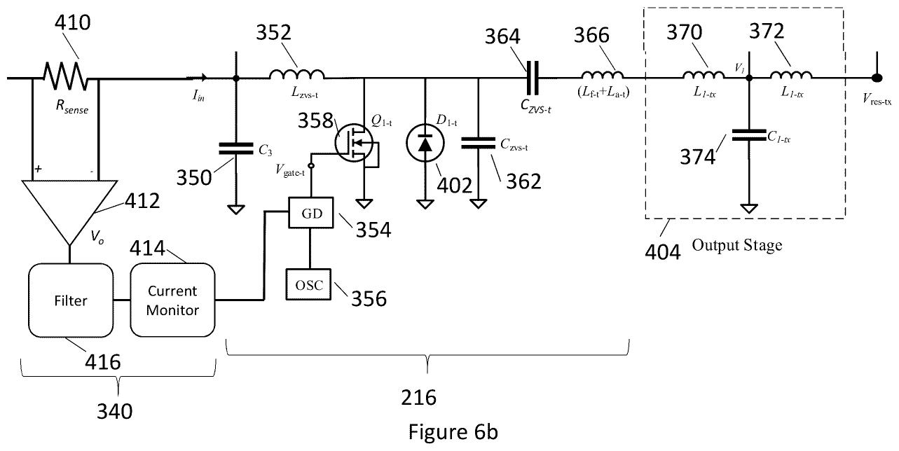

Turning to FIG. 6a, an arrangement of the overcurrent detection circuit 340 is shown. The overcurrent detection circuit 340 shuts down the transmitter 210, specifically, the inverter 216 of the transmitter 210 in response to a current exceeding a predetermined threshold. The current may exceed a threshold in response to an overcurrent event, e.g., a short circuit event such as a short circuit. As such, the overcurrent detection circuit 340 shuts down the inverter 216 in response to a detected short circuit event. The short circuit event may be initiated by the overvoltage protection circuit 360 at the receiver 220. The short circuit event may be the described electrical grounding of a switching element of a rectifier 224 of the receiver 220 by the overvoltage protection circuit 360.

In response to detecting the short circuit event, the overcurrent detection circuit 340 shuts down the transmitter 210. Specifically, in response to the short circuit event, the overcurrent detection circuit 340 stops the transmitting element 222 from generating a field and therefore stops wireless power transfer from the transmitter 210 to the receiver 220. The overcurrent detection circuit 340 detects the short circuit event by detecting an increase in a current at the transmitter 210. When the current increases, this may indicate over-coupling between the receiver element 229 and the transmitter element 222 indicating the overvoltage protection circuit 360 has electrically grounded a switching element of the rectifier 224 at the receiver 220.

Shutting down the transmitter 210 comprises controlling operation of the inverter 216 of the transmitter 210. Specifically, the overcurrent detection circuit 340 controls operation of switching elements of the inverter 216. Controlling operation of the switching elements comprises disabling driver circuits associated with the switching element.

As shown in FIG. 6a, the overcurrent detection circuit 340 is electrically connected to the DC/DC converter 214 and the inverter 216. The overcurrent detection circuit 340 comprises resistor 410, differential amplifier 412, current monitor 414 and filter 416. The resistor 410 is electrically connected to the differential amplifier 412. The differential amplifier 412 outputs a signal to the current monitor 414. The current monitor 414 controls operate of the inverter as will be described. The current monitor 414 outputs a control signal. In this arrangement, the output signal from the differential amplifier 412 is filtered by the filter 416 prior to being received at the current monitor 414. As one of skill in the art will appreciate, the filter 416 may be omitted.

The resistor 410 has a resistance Rsense and is for sensing a current at the output of the DC/DC converter 214. The resistance Rsense may be generally small, e.g., 0.01 Ohms. A differential amplifier 412 is electrically connected to each side of the resistor 410 to monitor the voltage drop across the resistor 410. Because V=IR, the current flowing through the known resistance Rsense of the resistor 410 may be calculated based on the voltage drop across the resistor 410. The amplifier 412 outputs a voltage signal that is equal to the voltage across its input terminals multiplied by a known gain factor (G). This gain factor is typically 25, 50, 100, or 200. That voltage signal is sent to the current monitor 414. In this arrangement, the current monitor 414 comprises a comparator with a reference voltage that controls the trip point, i.e., the current threshold at which the current monitor 414 shuts down the inverter 216. If the current exceeds a threshold, the current monitor 414 outputs a control signal. The output of the amplifier 412 is filtered by the filter 416 to avoid falsely tripping the current monitor 414 and inadvertently sending a control signal to shut down the inverter 216. The control signal controls operation of the inverter 216 as will be described.

The inverter 216 is adapted to convert the converted DC power signal from the DC/DC converter 214 to an alternating current (AC) signal. The inverter 216 may comprise a high frequency power inverter.

In the illustrated arrangement, the inverter 216 comprises capacitor 350, inductor 352, gate driver 354, clock generator 356, main switch 358, diode 402, capacitor 362, capacitor 364, and inductor 366. The capacitor 350 having capacitance C3 is connected in parallel to the DC/DC converter 214 at the output of the resistor 410 of the overcurrent detection circuit 340, and in parallel to the inductor 352 having inductance LZVS-t. The capacitor 350 is connected in parallel to the main switch 358 indicated as Q1-t. In the illustrated arrangement, the main switch 358 comprises an n-type MOSFET. While an n-type MOSFET has been illustrated, one of skill in the art will appreciate other FETs and switching devices may be used.

The main switch 358 is electrically connected to the gate driver 354 which is electrically connected to the clock generator 356. The gate driver 354 drives the main switch 358 of the inverter 216. The clock generator 356 is electrically connected to the gate driver 354. The clock generator 356 comprises an oscillator. One of skill in the art will appreciate the clock generator 356 may comprise any signal generator.

The clock generator 356 is configured to generate a clock signal to control the gate driver 354 connected to the main switch 358 to invert the inputted power signal from the power source 212 (via the DC/DC converter 214) to an RF or AC signal.

The inverter 216 further comprises a diode 402 indicated as D1-t electrically connected in parallel to the main switch 358, and the capacitor 362 having a capacitance CZVS-t electrically connected in parallel to the diode 402. The capacitor 362 is electrically connected to the capacitor 364 having a capacitance CZVS-t which is electrically connected in series to the inductor 366 having the inductance Lf-t+La-t. The main switch 358, diode 402 and capacitor 362 are connected in parallel between inductor 352 and capacitor 364.

As described, the current monitor 414 outputs a control signal if the current, determined based on a voltage across the resistor 410, exceeds a threshold. The control signal controls operation of the gate driver 354. While the current monitor 414 is illustrated as being connected to the gate driver 354, variations are possible as one of skill in the art would appreciate. For example, the current monitor 414 may be electrically connected to the oscillator 356, and the control signal may output by the monitor 414 may control operation of the oscillator 356 to control operation of the gate driver 354. In this arrangement, the output signal from the differential amplifier 412 is filtered by the filter 416 prior to being received at the current monitor 414. As one of skill in the art will appreciate, the filter 416 may be omitted.

The control signal output of the current monitor 414 controls operation of the gate driver 354 to shut down the transmitter 210. Specifically, the control signal shuts down the gate driver 354 such that the main switch 358 no longer inverts the inputted power signal from the power source 212 (via the DC/DC converter 214) to an RF or AC signal. The current at the resistor 410 exceeds a threshold when the voltage at the receiver 220 begins to drop due to the overvoltage protection circuit 360. This results in the current monitor stopping the inverter 216 from operating, by stopping switching of the main switch 358. The transmitter element 222 thus no longer generates a field for wireless power transfer, or generates a field having a reduced power, and the current begins to drop.

While a particular arrangement of the transmitter 210 has been described and illustrated in FIG. 6a, one of skill in the art will appreciate that variations are possible. For example, the transmitter 210 may further comprise an output stage 404 electrically connected to the output of the inverter 216 as illustrated in FIG. 6b. The DC/DC converter 214 and load 218 have been omitted for clarity.

In this arrangement, the output stage 404 is adapted to match the output impedance of the inverter 216 to the optimum impedance of the wireless power link between the transmitter element 222 and a corresponding receive element, e.g., receive element 229. The output stage 404 is additionally or alternatively adapted to filter high frequency harmonic components of the inverter 316. The output stage 404 is additionally or alternatively adapted to establish a quasi-current source behaviour at the connection point of the wireless link 230.

In the illustrated arrangement, the output stage 404 comprises inductor 370 having inductance L1-tx electrically connected in series to inductor 372 having inductance L1-tx with capacitor 374 having capacitance C1-tx electrically connected in parallel between the inductors 370, 372.

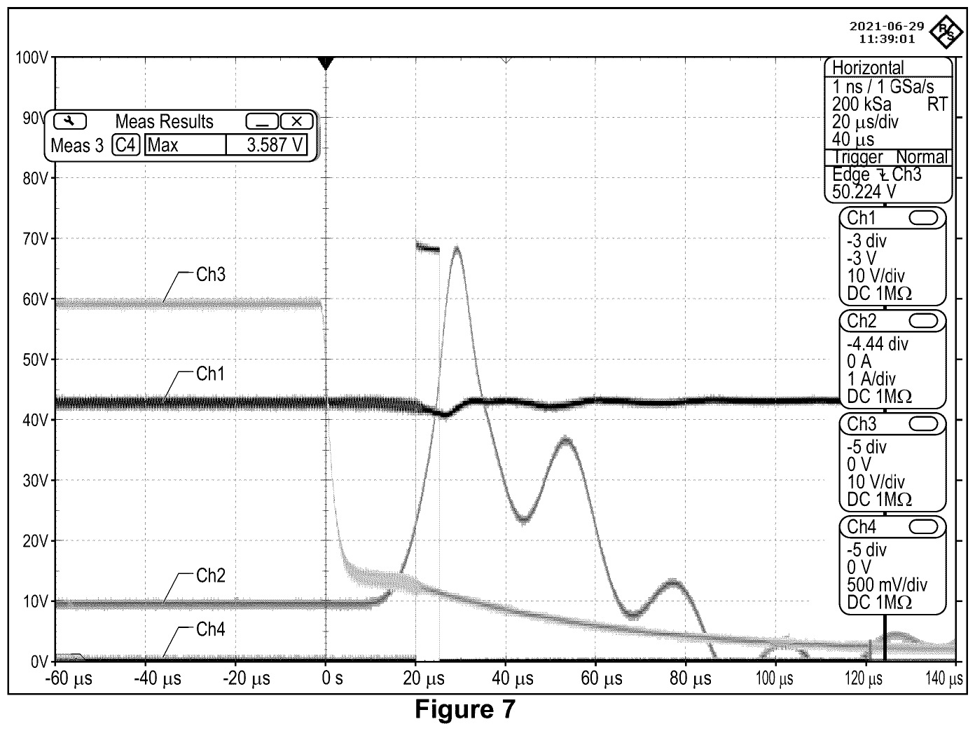

FIG. 7 is a plot of the rectified voltage Vrect at the receiver 220 (orange/brown trace), the input voltage Vin at the transmitter 210 (yellow trace), the input current lin at the transmitter 210 (purple trace) and the gate signal used to shut down the transmitter 210 (blue trace).

During operation of the overvoltage protection circuit 360 and overcurrent detection circuit 340, the voltage at the receiver 220 first exceeds a threshold, e.g., Vrect (orange/brown trace) exceeding 60V in FIG. 7. Prior to this point, the current in the transmitter lin (purple trace) is nominal around 0.5 A. Once this threshold is exceeded indicating over-coupling between transmitter and receiver elements 222, 229 which could lead to damage to components on the receiver 220, the overvoltage protection circuit 360 electrically grounds a switching element of the rectifier 224. The rectified voltage Vrect quickly falls to zero, i.e., at time 0 s. This prevents possible over-voltage from damaging components at the receiver 220.

As the voltage drops, the current at the at the transmitter 210 increases. As illustrated in FIG. 7 this occurs approximately 15 uS when the input current lin (purple trace) begins to increase. This is detected by the overcurrent detection circuit 340 in the manner described. In response overcurrent detection circuit 340 then controls the gate driver 354 to stop operation of the main switch 358 of the inverter 216. Specifically, when the input current lin exceeds a threshold, the control signal (blue trace) goes high. In FIG. 7 this occurs around 20 uS when the input current lin reaches approximately 1.5 A. The input current lin continues to rise for a few microseconds after the control signal has gone high, but then begins to decay. The current eventually returns to zero as the transmitter 210 shuts down and the receiver 220 loses power.

Once the voltage has reached zero, the inverter 216 and the transmitter 210 are shut down. The transmitter 210 may be left in the off state until a user re-starts the transmitter 210. Alternatively, the transmitter 210 may auto-restart. Once the power from the transmitter 210 is zero, due the transmitter 210 being off, the overvoltage protection circuit 360 switches to open. However, power will not return to the receiver 220, specifically the rectifier 224, until the transmitter 210 and inverter 216 have been restarted. Once the inverter 216 has been restarted, the transmitter element 222 may again transfer power to the receiver element 229 via field coupling. If the rectified voltage Vrect output by the rectifier 224 following power transfer is below the voltage threshold, the rectifier 224 will again output a voltage to the DC/DC converter 226 and load 228.

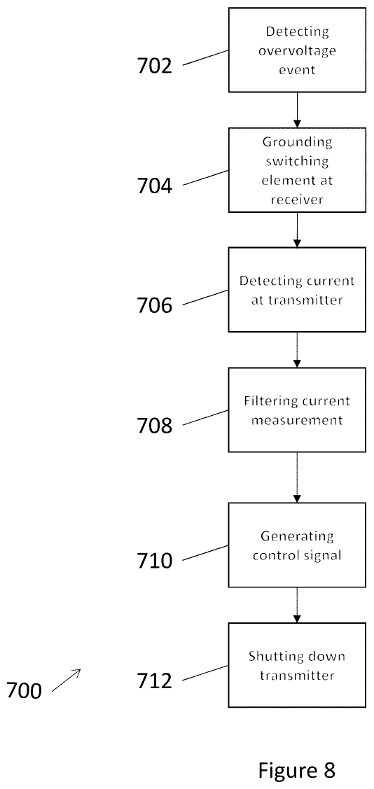

Turning now to FIG. 8, a flowchart of a method 700 of operating the circuits 360 and 340 is illustrated. At 702, the overvoltage protection circuit 360 detects an overvoltage event at the receiver 220. The overvoltage event may be over-coupling between the transmitter and receiver elements 222, 229. The over-coupling may cause an increase in voltage output by a switching element of the rectifier 224 of the receiver 220. Over-coupling may cause the voltage to exceed a pre-set threshold. Based on detecting the overvoltage event, the overvoltage protection circuit 360 grounds the switching element of the rectifier 224. In this way, the voltage by the rectifier 224 does not damage components of the DC/DC converter 226 or load 228 of the receiver which may not able to function at beyond the threshold voltage.

Electrically grounding the switching element of the rectifier 224 causes an increase in a current at the transmitter 210. Thus, the method 700 further comprises detecting 706 a current at the transmitter. The current is detected by the overcurrent detection circuit 340. Specifically, the circuit 340 detects and amplifies a voltage across a resistor 310 at the output of a DC/DC converter 214 of the transmitter 210. The voltage is then used to determine the current at the transmitter 210. Based on the current exceeding a threshold, the overcurrent detection circuit 340 generates a control signal at the current monitor 414. The current signal may be amplified by the amplifier 412 prior to being filtered 708 by the filter 416. The current monitor 414 determines if the current exceeds a threshold. If the current monitor 414 determines that a threshold is exceed, the monitor 414 generates 710 a control signal to shut down 712 the transmitter 210. Specifically, the control signal controls operation of a gate driver 354 which controls operation of a main switch 358 of an inverter 216 of the transmitter 210. In this way, the current begins to decrease. This protects transmitter 210 elements from damage from overcurrent.

Once the voltage at the receiver 220 has reached zero, the overvoltage protection circuit 360 switches to electrically open and the switching element of the rectifier 224 is no longer electrically grounded.

The inverter 216 needs to then be re-enabled before any voltage is seen by the receiver 220. If the inverter 216 is re-enabled and the transmitter 210 and receiver 220 are still overcoupled, the overvoltage protection circuit 360 will simply trip again. Thus, the overvoltage event needs to be removed. For example, the transmitter 210 and receiver 220 may be moved farther from each other to increase the separation distance between the transmitter element 222 and receiver element 229. Once the overvoltage event is removed, the inverter 216 can be re-enabled by, for example, re-enabling the gate driver 258. The transmitter 210 restarts and the transmitter element 222 again generates a field. The receiver element 229 extracts power from this field and the output of the rectifier 226 increases.

If a further overvoltage event is detected at the receiver 220, the method 700 may be repeated to again electrically ground a switching element of the rectifier 224 and protect electrical components of the receiver.

It should be understood that the examples provided are merely exemplary of the present disclosure, and that various modifications may be made thereto.

1. An overcurrent detection circuit for use in a transmitter of a wireless power transfer system, the transmitter comprising a transmitter element for generating a field to transfer power to a receiver of a wireless power transfer system,
the overcurrent detection circuit adapted to shut down a transmitter of a wireless power transfer system in response to a detected overcurrent event.

2. The circuit of claim 1, wherein the overcurrent event comprises a short circuit.

3. The circuit of claim 2, wherein the short circuit is initiated by an overvoltage protection circuit at a receiver of a wireless power transfer system, or wherein the short circuit is initiated by the overvoltage protection circuit electrically grounding a component of a receiver of the wireless power transfer system to which the transmitter is transferring power.

4. The circuit of claim 1, further comprising at least one of a voltage detector for detecting a voltage at the circuit, and a filter for filtering a signal at the circuit.

5. The circuit of claim 1, wherein the circuit is adapted to control operation of an inverter electrically connected to the transmitter element in response to the detected overcurrent event, wherein the circuit is adapted to control operation of one or more switching elements of the inverter, and wherein the circuit is adapted to disable one or more driver circuits associated with the switching elements of the inverter.

6. An overvoltage protection circuit for use in a receiver of a wireless power transfer system, the receiver comprising a receiver element for extracting power from a field generated by a transmitter of a wireless power transfer system, and a switching element electrically connected to the receiver element,
the overvoltage protection circuit adapted to electrically ground the switching element based on an overvoltage event.

7. The overvoltage protection circuit of claim 6, wherein the overvoltage protection circuit is electrically connected to an output of the switching element, and wherein the overvoltage protection circuit is adapted to detect the overvoltage event.

8. The overvoltage protection circuit of claim 6, wherein the overvoltage event corresponds to over-coupling between the receiver element and a transmitter element of a transmitter of a wireless power transfer system.

9. The overvoltage protection circuit of claim 6, wherein the overvoltage protection circuit is adapted to monitor a voltage, and wherein the voltage is at an output of the receiver element.

10. The overvoltage protection circuit of claim 6, wherein the overvoltage protection circuit is adapted to be electrically open when a voltage at the receiver element is below a threshold value, and wherein at least one of:
the overvoltage protection circuit is adapted to short circuit the switching element to ground when the voltage at the switching element exceeds the threshold value; and
the overvoltage protection circuit is adapted to again be electrically open when no power signal is present at the switching element.

11. The overvoltage protection circuit of claim 6, wherein the overvoltage protection circuit comprises at least one of a switching element, a latching element, and a triode for alternating current (TRIAC).

12. A method of protecting a switching element of a receiver of a wireless power transfer system from a receiver element of the receiver, the receiver element for extracting power from a field generated by a transmitter of a wireless power transfer system, the method comprising:
electrically grounding, via an overvoltage protection circuit, a switching element of a receiver, the overvoltage protection circuit electrically connected to the switching element and the receiver element.

13. The method of claim 12, further comprising:
tapping the overvoltage protection circuit off of the receiver element.

14. The method of claim 12, wherein the electrically grounding comprises electrically grounding the switching element based on an overvoltage event, and wherein the overvoltage event corresponds to over-coupling between the receiver element and a transmitter element of a transmitter of a wireless power transfer system.

15. The method of claim 12, further comprising:
opening the overvoltage protection circuit when a voltage at the receiver element is below a threshold value;
short circuiting, via the overvoltage protection circuit, the receiver element to ground when the voltage at the receiver element is below a threshold value; and
re-opening the overvoltage protection circuit when no power signal is present at the receiver element.

16. A method of detecting overcurrent at a transmitter of a wireless power transfer system, the transmitter comprising a transmitter element for generating a field to transfer power to a receiver of a wireless power transfer system, the method comprising:
shutting down a transmitter of a wireless power transfer system in response to a detected an overcurrent event.

17. The method of claim 16, wherein the overcurrent event comprises a short circuit.

18. The method of claim 17, furthering comprising:
detecting a current increase at the transmitter to detect the short circuit.

19. The method of claim 17, further comprising:
filtering a signal at the transmitter, wherein the signal is the detected current.

20. The method of claim 16, wherein shutting down the transmitter comprises controlling operation of an inverter electrically connected to a transmitter element of the transmitter.
